(19) United States
(12) Patent Application Publication
(10) Pub. No.: US 2008/0098150 A1
(43) Pub. Date: Apr. 24, 2008

(54) METHOD FOR FORMING ROUTE MAP IN WIRELESS 1394 BRIDGE NETWORK

(76) Inventors: Il-Soon JANG, Chungbuk (KR); Seong-Hee PARK, Daejon (KR); Seong-Hee LEE, Seoul (KR); Sang-Sung CHOI, Daejon (KR)

Correspondence Address: LADAS & PARRY LLP, 224 SOUTH MICHIGAN AVENUE, SUITE 1600, CHICAGO, IL, 60604, US

(21) Appl. No.: 11/877,000

(22) Filed: Oct. 23, 2007

(30) Foreign Application Priority Data
Oct. 24, 2006 (KR) 10-2006-0103590
Dec. 7, 2006 (KR) 10-2006-0123985

(51) Int. Cl. G06F 13/00

(52) U.S. Cl. 710/312

(57) ABSTRACT

Provided is a method for forming a route map in a wireless 1394 bridge network. The method for forming a route map in a wireless 1394 bridge network, including the steps of: a) storing route map information; b) collecting changed bus information when a new network is formed according to addition/removal of a bridge; c) checking whether a quantity of the collected bus information exceeds a threshold; d) forming a route map having all bus information when the quantity of the collected bus information exceeds a threshold; and e) forming a route map having changed bus information when collected bus information does not exceed the threshold.

### CROSS-REFERENCE S TO RELATED APPLICATIONS

The present invention claims priority of Korean Patent Application Nos. 10-2006-0103590 and 10-2006-0123985, filed on Oct. 24, 2006, and Dec. 7, 2006, respectively, which are incorporated herein by reference.

### BACKGROUND OF THE INVENTION

1. Field of the Invention

The present invention relates to a method for forming a route map in a wireless 1394 bridge network; and, more particularly, to a method for forming a route map in a wireless 1394 bridge network for reducing the number of retransmissions, a transmission delay time and system load of a packet by forming a new route map based on changed information and reducing the quantity of data transmitted in a wireless section.

This work was supported by the Information Technology (IT) research and development program of the Korean Ministry of Information and Communication (MIC) and/or the Korean Institute for Information Technology Advancement (IITA) [2006-S-071-01, “Development of UWB Solution for High Speed Multimedia Transmission”].

2. Description of Related Art

FIG. 1 shows a typical wired IEEE 1394 bridge network. Referring to FIG. 1, a bridge 11 includes two portals 12 and 13. Each portal is not connected through an Institute of Electrical and Electronic Engineers (IEEE) 1394 bus, but is connected through First In First Output (FIFO).

An IEEE 1394 packet that the portal 12 receives may be processed by the portal 12 itself, or may be transmitted to the co-portal 13 according to a destination through FIFO.

Each portal has a different bus identification (ID) and the bus ID is unique in a network. A maximum of 63 nodes may exist in a bus and a portal is considered as a node. In the IEEE 1394 , the bus ID is expressed as 10 bits, and 1024 buses exist. Only the buses ranging 0 to 1022 can be used. Herein, a 1023 bus means a local bus.

When a new wired IEEE 1394 bridge network is connected with the wired IEEE 1394 bridge network, a new configuration for an integrated network is designed. That is, each bridge collects a route map of a large quantity with respect to 1023 buses as shown in FIG. 2. A data format for transmitting the route map is as shown in FIG. 3.

Subsequently, the bridge 11 determines whether the received packet is transmitted to another bridge which is connected with the bridge 11 according to the destination bus ID of the packet. An information value is expressed as 2 bits and has 4 types of CLEAN 0, VALID 1, FORWARD 2, and DIRTY 3.

Therefore, the portal receiving a packet transmits the packet to a co-portal when a value of the bus ID is ‘FORWARD’ in a route map. The portal does not transmit the packet when the value of the bus ID is ‘VALID’.

There are ‘CLEAN’ and ‘DIRTY’ as values of another state. The ‘CLEAN’ means a bus ID which is not used in a current network. When a packet having the value of ‘CLEAN’ is received, the packet is discarded.

The ‘DIRTY’ is a state value which is used for network update, and means that the bus ID is used in another place. Accordingly, when the network is completely updated, the bus ID of the ‘DIRTY’ state is changed into the bus ID of the ‘CLEAN’ state.

When own bus ID is updated in the network and changed into ‘DIRTY’, the portal requests and receives a new bus ID before the network is updated after receiving the route map message.

When the network is updated, a coordinator transmits a new route map of 2048 bits. Therefore, when a route map is transmitted in a wireless section, a transmission size is varied according to a transmitting method of a lower layer such as Ultra Wide Band (UWB) and IEEE 1802.13.5.

Generally, when a channel code rate of a physical layer is ⅓, a data transmission size is 3×2048 bits.

In the wireless section, transmission of data is delayed and a load of a system increases. Also, the error rate is higher in the wireless section than in the wired section. Accordingly, there is a problem in the wireless section that the number of data retransmissions increases due to characteristics of the wireless section.

### SUMMARY OF THE INVENTION

An embodiment of the present invention is directed to providing a method for forming a route map in a wireless 1394 bridge network for reducing the number of retransmissions, a transmission delay time and a system load of a packet by forming a new route map based on changed information and reducing the quantity of data transmitted in a wireless section.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a method for forming a route map in a wireless 1394 bridge network, including the steps of: a) storing route map information; b) collecting changed bus information when a new network is formed according to addition/removal of a bridge; c) checking whether a quantity of the collected bus information exceeds a threshold; d) forming a route map having all bus information when the quantity of the collected bus information exceeds a threshold; and e) forming a route map having changed bus information when collected bus information does not exceed the threshold.

Also, the present invention reduces route map information transmitted in 1394 network configuration in Protocol Adaptation Layer (PAL) for transmission in a wireless section among a plurality of serial bus protocols.

### BRIEF DESCRIPTION OF THE DRAWINGS

FIG. 1 shows a typical wired IEEE 1394 bridge network.

FIG. 2 shows a route map formed in the wired IEEE 1394 bridge network.

FIG. 3 shows a route map format formed in the wired IEEE 1394 bridge network.

FIG. 4 shows a bridge of a wireless 1394 bridge network to which the present invention is applied.

FIG. 5 shows a packet which is created in a Protocol Adaptation Layer (PAL) and transmitted to IEEE 802.12.3 in accordance with an embodiment of the present invention.

FIG. 6 shows the wireless 1394 bridge network to which the present invention is applied.

FIG. 7 shows a route map format formed in a wireless 1394 bridge network in accordance with an embodiment of the present invention.

FIG. 8 is a flowchart describing a method for forming a route map in the wireless 1394 bridge network in accordance with an embodiment of the present invention.

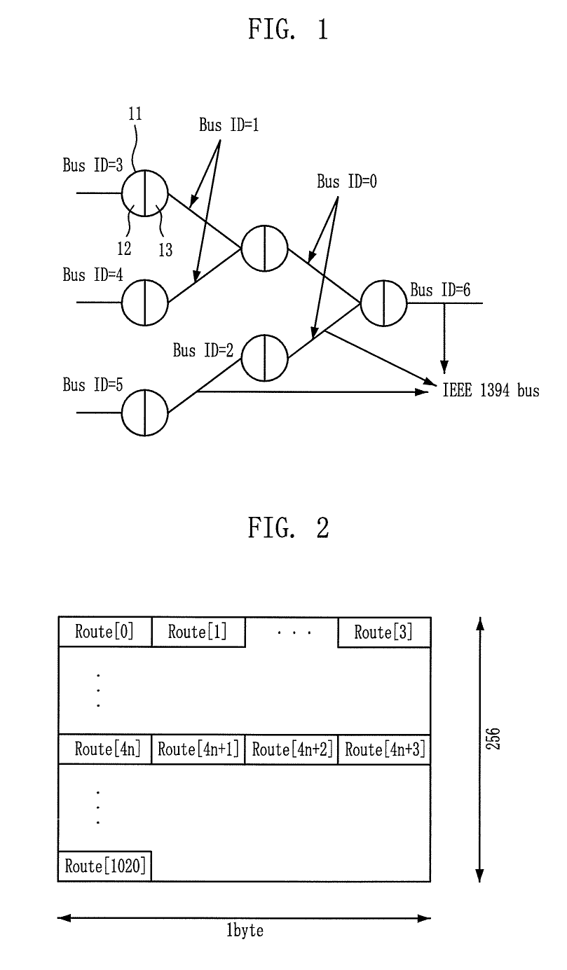

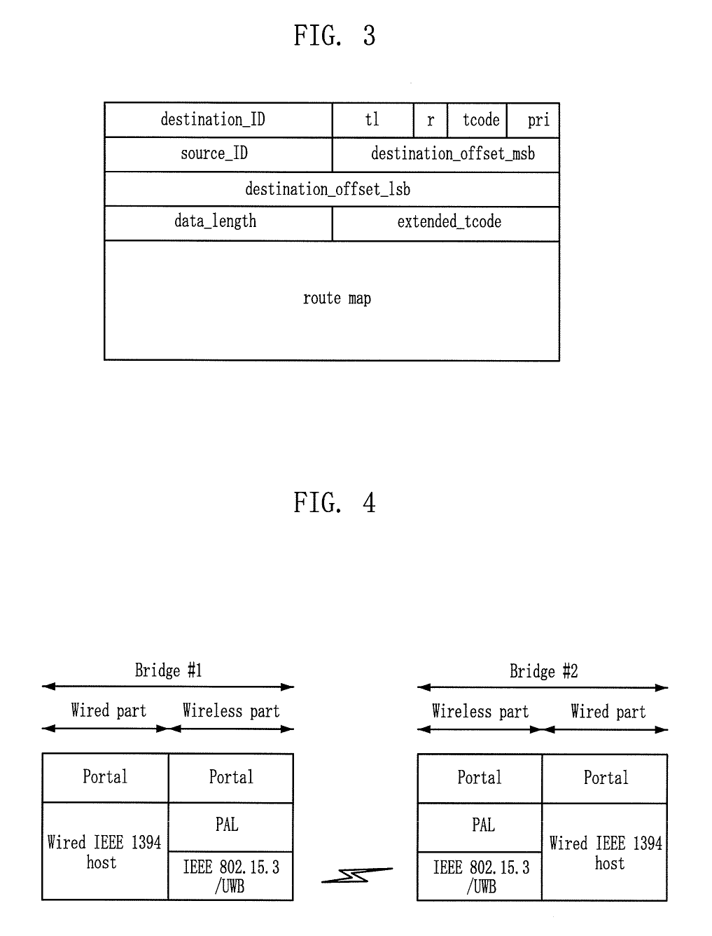

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

FIG. 4 shows a bridge of a wireless 1394 bridge network to which the present invention is applied.

Referring to FIG. 4, the bridge of the wireless 1394 bridge network to which the present invention is applied includes a wired IEEE 1394 portal and a wireless IEEE 1394 portal. The wired IEEE 1394 portal is connected through a wire and the wireless IEEE 1394 portal is wirelessly connected.

The wireless IEEE 1394 portal exists on an MAC/PHY layer of the wireless protocol and includes Protocol Adaptation Layer (PAL) supporting connection between the wired IEEE 1394 and the wireless protocol. The PAL exists between the wireless protocol and upper protocol such that a plurality of upper protocols can be connected with a wireless protocol.

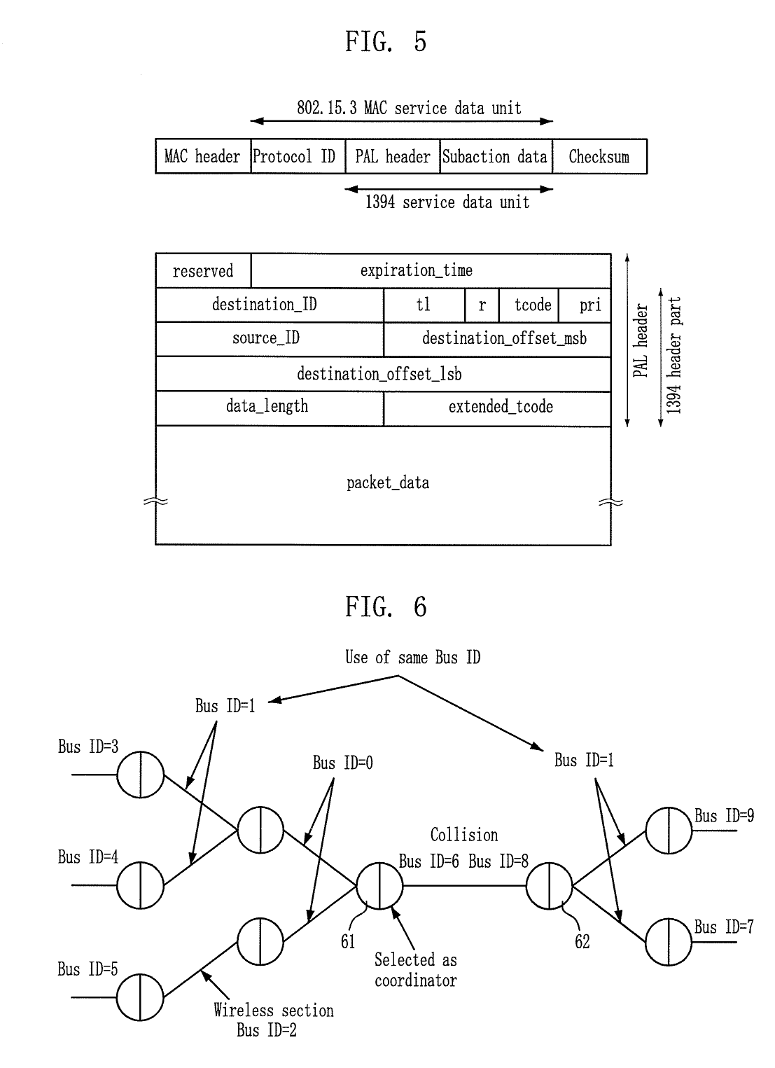

The wireless protocol includes a Ultra Wide Band (UWB) and IEEE 802.13.5 and will be described using IEEE 802.15.3 as an example. A format of a packet which is formed in a PAL layer and transmitted to the IEEE 802.15.3 is as shown in FIG. 5.

FIG. 6 shows the wireless 1394 bridge network to which the present invention is applied and it shows a state that two wired IEEE 1394 networks including a wireless bridge is connected.

Referring to FIG. 6, when a bridge 61 with a bus ID of 6 is connected with a bridge 62 with a bus ID of 8, a collision occurs. Therefore, a route map having changed bus information is formed.

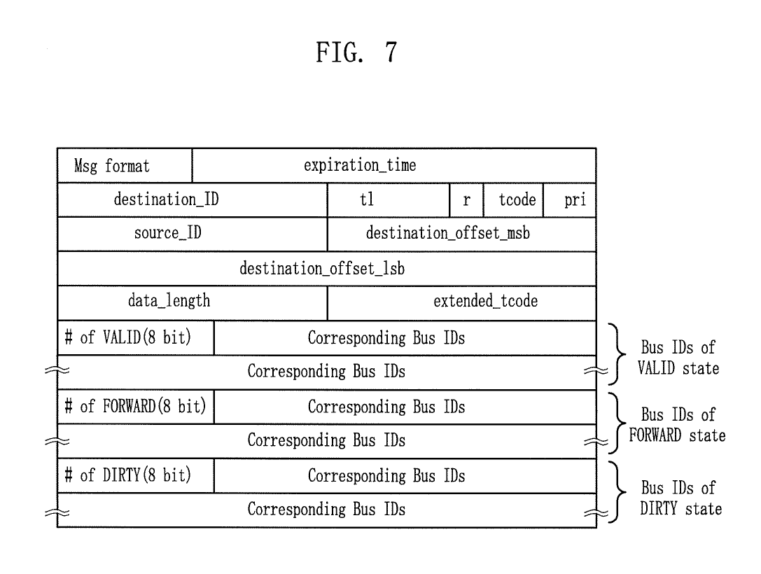

FIG. 7 shows a route map format formed in a wireless 1394 bridge network in accordance with an embodiment of the present invention. The route map format is transmitted in a wireless section when a new network is formed.

The route map includes only changed bus information of entire bus information.

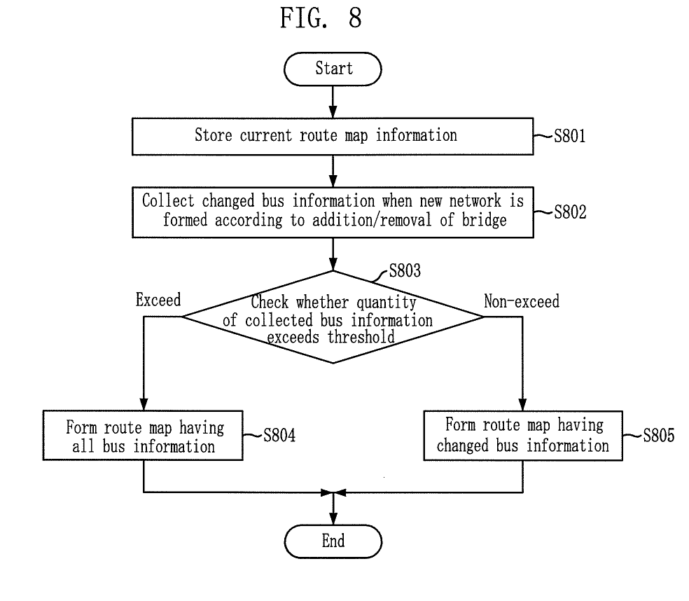

FIG. 8 is a flowchart describing a method for forming a route map in a wireless 1394 bridge network in accordance with an embodiment of the present invention.

Current route map information is stored at step S801.

When a new network is formed according to addition/removal of a bridge, changed bus information is collected at step S802. The bus information is collected according to each state with respect to all bus IDs except “CLEAN”.

It is checked at step S803 whether the quantity of the collected bus information exceeds 2048 bits.

When it turns out at step S803 that the quantity of the collected bus information exceeds a threshold, a route map having all bus information is formed at step S804.

When it turns out at step S803 that the quantity of the collected bus information does not exceed the threshold, a route map having changed bus information is formed at step S805.

The present invention can reduce the number of retransmissions, a transmission delay time and system load of a packet by forming a new route map based on changed information and reducing the quantity of data transmitted in a wireless section.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

While the present invention has been described with respect to the specific embodiments, it will be apparent to those skilled in the art that various changes and modifications may be made without departing from the spirit and scope of the invention as defined in the following claims.

What is claimed is:

1. A method for forming a route map in a wireless 1394 bridge network, comprising the steps of:
a) storing route map information;
b) collecting changed bus information when a new network is formed according to addition/removal of a bridge;
c) checking whether a quantity of the collected bus information exceeds a threshold;
d) forming a route map having all bus information when the quantity of the collected bus information exceeds a threshold; and
e) forming a route map having changed bus information when collected bus information does not exceed the threshold.

2. The method of claim 1, wherein the route map having the changed bus information includes a ‘FORWARD’ field, a ‘VALID’ field, and a ‘DIRTY’ field.

3. The method of claim 1, wherein the threshold is 2048 bits.
